(19) United States
(12) Patent Application Publication
(10) Pub. No.: US 2009/0324069 A1
(43) Pub. Date: Dec. 31, 2009

(54) IMAGE PROCESSING DEVICE, IMAGE PROCESSING METHOD, AND COMPUTER READABLE MEDIUM

(75) Inventor: Yoshinori Kawai, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/483,815

(22) Filed: Jun. 12, 2009

(30) Foreign Application Priority Data
Jun. 25, 2008 (JP) 2008-166326

(51) Int. Cl. G06K 9/46

(52) U.S. Cl. 382/165; 382/190; 382/167

(57) ABSTRACT

An image processing device having an image processing unit configured to perform a first or a second image processing selectively for a target area of an image data is provided. The image processing device comprises a determining unit configured to determine an image processing selected from the first and second image processing and a detecting unit configured to detect a target area for an inputted image data. If it is determined that the first image processing is performed, the image processing unit performs the first image processing for the target area of the image data, based on photographing information added to the image data in advance. If it is determined that the second image processing is performed, the image processing unit performs the second image processing for the target area detected by the detecting unit.

### BACKGROUND OF THE INVENTION

1. Field of the Invention

The present invention relates generally to an image processing device, an image processing method, and a computer readable medium. Particularly, the present invention relates to the image processing device and the method thereof which switch a detection result to be used based on a type of an image processing and relates to the computer readable medium storing a computer program for the method, when an image generating device such as a digital camera and an image outputting device such as a printer have a similar detection process.

2. Description of the Related Art

In photographing, all photographs are not necessarily taken properly. The failure photograph due to underexposure, overexposure, a backlight, a topping, a red-eye, etc. is taken in many cases resulting from a photographing situation and a subject photographed, etc. In photographing by a traditional silver salt film camera, there was little necessity that a user cares since the correction was performed by a print shop at the time of developing or printing. However, in photographing by the digital camera which has become widely used in recent years, the user can perform procedures from the photographing to the printing by oneself. Therefore, it becomes necessary to perform the correction of the above-mentioned failures in the user's environments. Then, manufacturers of applications or printers have analyzed the histogram or the like of photographed image data and have developed a technology for the automatic correction thereof to be installed in the applications and printers or the like.

By the way, humankind is the most important at the photographing and it is required that humankind and a face thereof become optimum. In order to perform further better correction, the technology which carries out the correction or the like by detecting a face area automatically out of the image data and by using the detected information of the face area, has been developed and implemented.

On the other hand, in the digital camera, technologies for the optimum result to be acquired for humankind at the time of photographing is now developed. For example, the technologies are such that the face area is detected at the time of photographing, and the detected face area is focused, and the exposure is decided so that the exposure of the detected face area will become the optimum.

Therefore, the development of the technology using the face area detected at the time of photographing by the digital camera has started. A method of adding the face area detected at a digital camera side to the image data, and of using the added face area in the automatic trimming at the time of the printing (Japanese Patent Laid-Open No. 2004-207987), and a method of using the face area detected at the digital camera side for the automatic correction at a the printer side (Japanese Patent Laid-Open No. 2007-213455) have been developed.

Realized has been a situation in which a face detecting technology is installed in both the digital camera and the printer, and a plurality of face detecting technologies can exist in a series of workflows from the photographing to the printing. Furthermore, various methods such as image correction, image retouching and the image processing based on the application of the face detection have been newly devised. For example, these are skin smoothing, smile capturing, and distribution processing based on human sensing or the like.

In both of the laid-open publications mentioned above, the printer side does not have a detecting function of the face area and incorporates only the utilization of the face area detected by the digital camera. However, since the conventional technologies mentioned above cannot be used in the digital camera which does not have the detecting function of the face area, the face area detecting function at the side of the printer is indispensable. In the conventional technologies, the case where both the digital camera and the printer have the detecting function of the face area is not taken into consideration. Therefore, it is necessary to determine a process flow for the case where both the digital camera and the printer have the detecting function of the face area.

The face area to be detected may change with a detection algorithm or the like. For example, there are such differences that only a skin-colored area including an eye/nose/mouth is the face area, or the area further including a hair and a background in addition to above-mentioned face area is the face area. That is, the face area added to the image data may differ depending on a model of the digital camera. The face area detected within the printer and the face area detected by the digital camera differ if the detection algorithm differs.

For example, a backlight correction process and a red-eye correction process use the detected face area. The red-eye correction process or the like using the face area detects the red-eye in the detected face area. In either case of the face area of only the skin-colored area including the eye/nose/mouth and the face area further including the hair and the background in addition thereto, the red-eye is detected if the red-eye is included in the face area, and the difference of the detected face area has no influence.

The backlight correction process analyzes a color distribution of the face area in order to optimize brightness in the face area. In that case, when there is the difference of the face area detected by a device, the difference comes out also in the computed color distribution of the face area. When the color distribution differs, the correction amount also differs. When the face area of only the skin-colored area including the eye/nose/mouth is compared with the face area further including the hair and the background in addition thereto, the face area including the hair increases the distribution of a dark portion more, and the exposure therein may be decided to be insufficient. When the detection result of the face area detected by the digital camera is used as it is in the image correction by the printer as shown in Japanese Patent Laid-Open No. 2004-207987 and No. 2007-213455, an optimum result may not be acquired depending on a type of the camera (the difference of the detected face area).

Thus, considered is the case where the image correction and retouching is performed with the detection result of the digital camera utilized as it is as shown in Japanese Patent Laid-Open No. 2004-207987 and No. 2007-213455. Depending on the type of process, there are two cases where, since the acquired result compare favorably and the face detection is not performed at the side of the printer, a speedup of the image processing can be aimed at and where, although the speedup can be aimed at, the optimum result is not acquired depending on the type of the camera. In the conventional technologies, the latter case will become a large problem.

An object of the present invention is to acquire the optimum processing result at the side of the printer without being based on the type of the camera.

### SUMMARY OF THE INVENTION

The present invention provides an image processing device having an image processing unit configured to perform a first or a second image processing selectively for a target area of an image data. The image processing device comprises a determining unit configured to determine an image processing selected from the first and second image processing and a detecting unit configured to detect a target area for an inputted image data. If it is determined that the first image processing is performed, the image processing unit performs the first image processing for the target area of the image data, based on photographing information added to the image data in advance. If it is determined that the second image processing is performed, the image processing unit performs the second image processing for the target area detected by the detecting unit.

The present invention mentioned above enables an image processing flow to be realizable both in the case that the target area is added to the inputted image data in advance and in the case that the target area is detected for the inputted image data.

Furthermore, also when the target area detected by different detection algorithm is added to the inputted image data, the detection result of the target area to be used can be switched according to the selected image processing. Thereby, the speedup of the image processing for the image in two cases mentioned above and optimization of the image processing result become possible.

Further features of the present invention will become apparent from the following description of exemplary embodiments (with reference to the attached drawings).

### BRIEF DESCRIPTION OF THE DRAWINGS

FIG. 1 is a block diagram showing an illustrative hardware configuration inside a printing device to which the present invention is applicable;

FIG. 2 shows a illustrative connection environment of the printing device where the present invention is implemented;

FIG. 3 shows another illustrative connection environment of the printing device where the present invention is implemented;

FIG. 4 illustrates a system block diagram according to image generating in an embodiment of the present invention;

FIG. 5 illustrates an explanatory view of face information included in tag information;

FIG. 6 illustrates an explanatory view of the image tag information;

FIG. 7 illustrates a flow chart of image generating in an embodiment of the present invention;

FIG. 8 illustrates a system block diagram according to an image output in an embodiment of the present invention;

FIG. 9 is an explanatory view illustrating an example of a face area (face area of only a skin-colored area including an eye/nose/mouth) in an embodiment of the present invention;

FIG. 10 is an explanatory view illustrating another example of the face area with hair and a background besides the face area shown by FIG. 9 in an embodiment of the present invention;

FIG. 11 illustrates a histogram of the face area of FIG. 9 in an embodiment of the present invention;

FIG. 12 illustrates a histogram of the face area of FIG. 10 in an embodiment of the present invention;

FIG. 13 is an explanatory diagram illustrating databases of image processing corresponding to detectors to be used in an embodiment of the present invention;

FIG. 14 is a flow chart illustrating a processing procedure of an image output in a first embodiment of the present invention; and

FIG. 15 is a flow chart illustrating a processing procedure of an image output in a second embodiment of the present invention.

### DESCRIPTION OF THE EMBODIMENTS

### First Embodiment

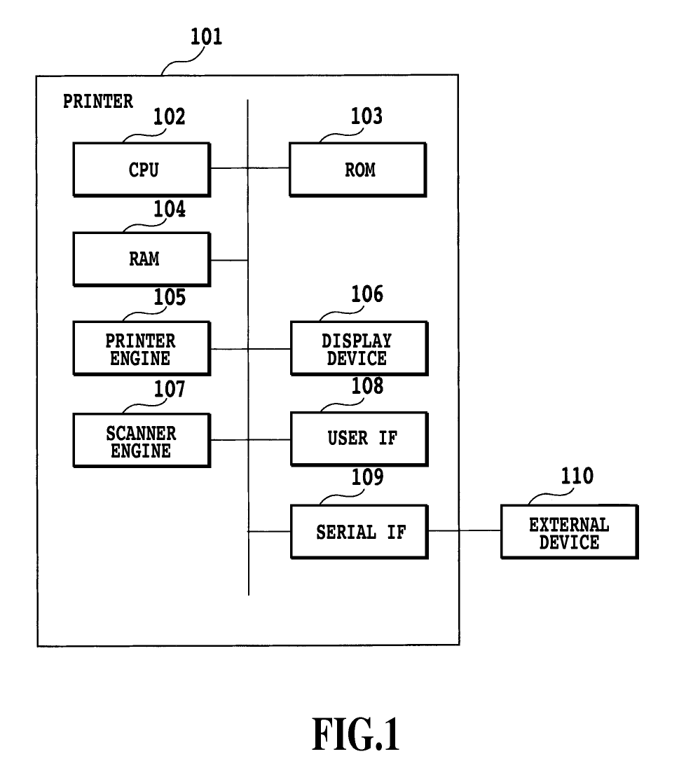

FIG. 1 illustrates an example of a hardware configuration of a printer 101 which is an image processing device to which the present invention is applicable. A CPU 102, a ROM 103, a RAM 104, and furthermore a printer engine 105 for performing print processing are installed inside the printer. In recent years, since a multifunction device with a scanner installed in the printer has become conspicuous, there is a case where the device has a scanner engine 107 for reading a manuscript depending on the case. A display device 106 is used in order to perform various setting regarding a paper sheet, printing quality, etc., during the printing. Reference numeral 108 indicates a user interface such as a button and a touch panel, and reference numeral 109 indicates an interface connecting with a personal computer or the like. A state where the devices mentioned above are connected via a system bus is a basic structure of the inside of the printer.

In addition, various components are possible to compose the printer. For example, they are a power supply, a feeder portion for handling the paper sheet, an interface connecting with a network directly or the like. However, in the present embodiment, since they are not mentioned directly, descriptions thereof are omitted here.

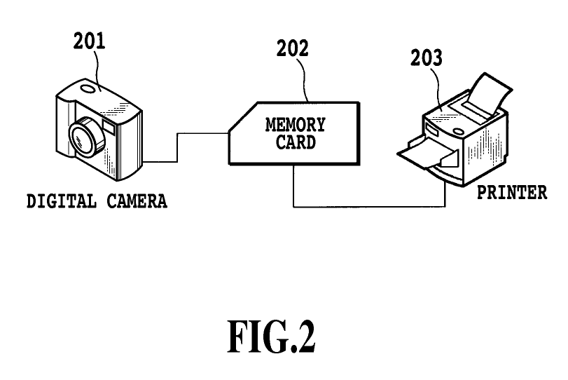

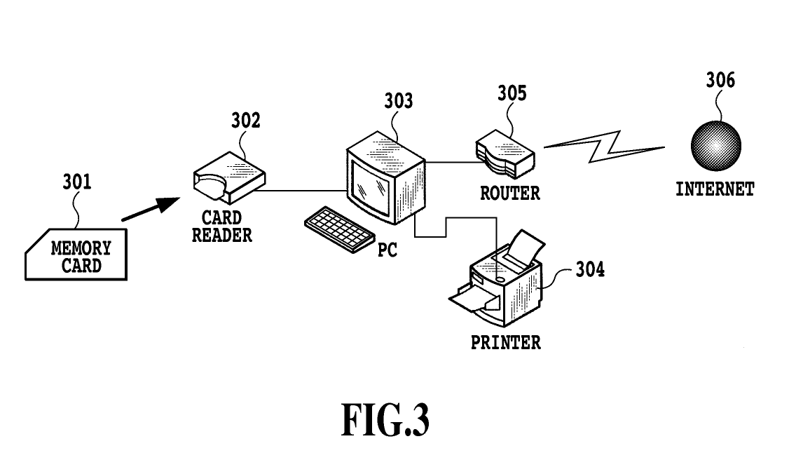

FIG. 2 and FIG. 3 show an example of a printing environment where the present invention can be implemented. FIG. 2 illustrates a configuration for printing an image data photographed by a digital camera. The image data photographed by the digital camera 201 are stored in a memory card 202 which is connected to the printer 203. The photographed image data are printed by the printer 203.

FIG. 3 illustrates an example of the printing environment where the personal computer is a main component. The personal computer 303 has a hard disk. In the hard disk, the image data of the memory card 301 is stored via a card reader 302, and the image data downloaded by being connected to the Internet 306 via a router 305 is stored, and the data acquired via various routes as mentioned above are stored. The data stored in the hard disk are printed by the printer 304 which is operated by the personal computer 303.

As mentioned above, the present embodiment may have a configuration in which an image output such as the printing of the image data generated by an image generating device such as the digital camera is performed by an image output device such as the printer.

Although a combination of the image generating device and the image output device will be described as the combination of the digital camera and the printer, a following combination may be possible. That is, a combination of the scanner and the printer, the digital camera and a monitor (image processing application), the monitor (image processing application) and the printer, or the like, may be possible.

Hereinafter, the image generating device of the present embodiment will be described.

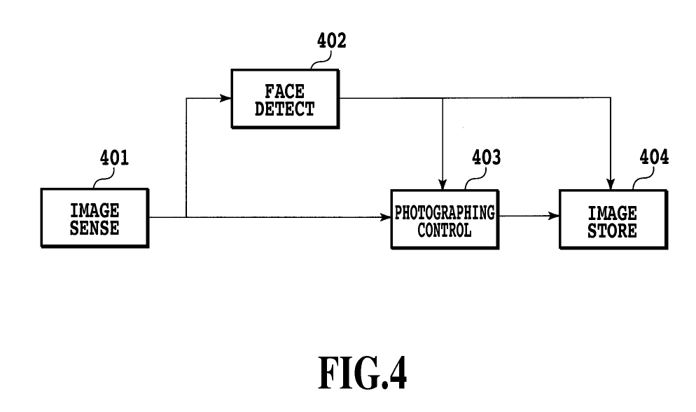

FIG. 4 illustrates a series of components in the configuration at the time of generating the image data by the image generating device such as the digital camera. A case where controlling an exposure or the like and generating the image data, are performed by using the face information detected at the time of photographing will be described as an embodiment. In the image generating device, it is important that certain face detection is performed and the detected face area is added to the image data to be stored. Therefore, the image generating device may perform only the face detection for the image data after the photographing and may store the image data with the detection result added thereto, and may correct the image data using the detection result and store the corrected image data with the detected result added thereto.

The image generating device includes an image sensing unit 401, a face detecting unit 402, a photographing control unit 403, and an image storage 404.

The image sensing unit 401 converts a subject into a signal value by an image sensor such as a CCD.

The face detecting unit 402 determines and detects whether the face area is included in the data acquired by the image sensing unit 401. As for the face detection method, any kind of method such as a method using the already proposed pattern matching, or the learned data based on a neural network may be used for the detection.

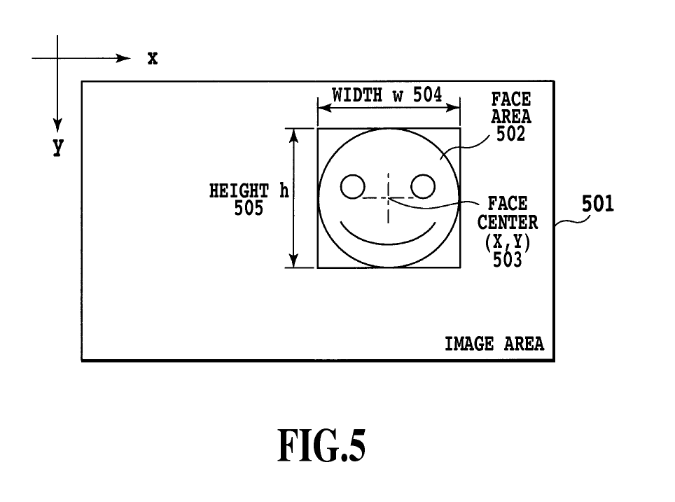

FIG. 5 illustrates the face detection result. The face detection is performed by an arbitrary algorithm in an image area 501. When the face area 502 is detected in the image area 501, the face detecting unit 402 outputs a center coordinate of the face area (face center coordinate 503), a width of the face area (face width W 504), and a height of the face area (face height H 505) as the detection results. In addition, the face detecting unit 402 may output a rotation angle, etc.

The face detecting unit 402 of FIG. 4 detects the center coordinate of the face area, the width, and the height from the signal value acquired from the image sensing unit 401 to be outputted to the photographing control unit 403 and the image storage 404 as the detection result.

The control unit 403 performs photographing control to generate the image data by determining an optimum photographing condition from the signal value acquired by the image sensing unit 401 and the information of the face area detected by the face detecting unit 402.

The photographing condition such as an exposure time, an aperture used in the control or the like is sent to the image storage 404 together with the image data.

The image storage 404 adds the photographing condition and the detection result of the face area to the image data to be stored as tag information.

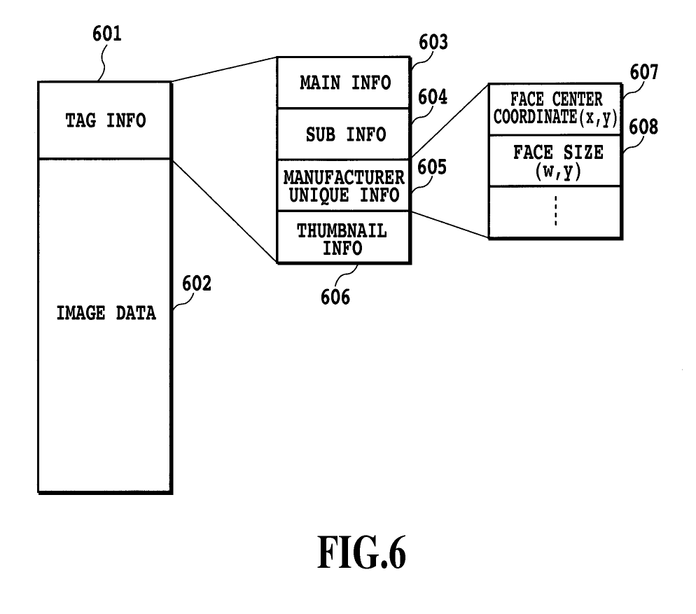

The tag information will be described using FIG. 6 which illustrates a data structure of the image data to be stored. The image data to be stored are divided into a tag information part 601 and an image data part 602.

The photographed image information is stored in the image data part 602. The tag information (photographing information) 601 is divided into main information 603, sub information 604, manufacturer unique information 605, and thumbnail information 606.

In the main information 603, the information regarding the date at the time of photographing, a model name or the like is stored. In the sub information 604, the information including a compressed mode of the image, color space, a number of pixels or the like is stored. In the manufacturer unique information 605, the information issued uniquely by the input device development manufacturer is stored. In the thumbnail information 606, the contraction image generated from the photographed image data is stored for a preview.

The face detection result is stored in the manufacturer unique information 605. The face detection results, the center coordinate of the face 607 and the size of the face (the width and height of the face area) 608 in detail, are stored.

The image storage 404 adds the tag information (photographing information) to the image data to be stored.

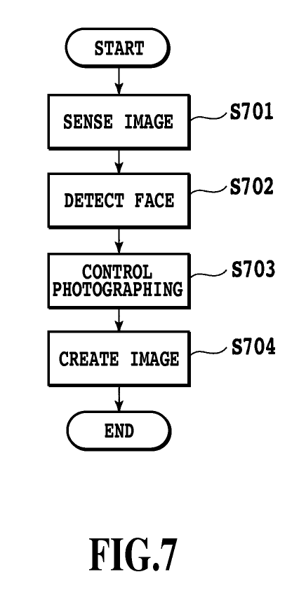

Subsequently, the operation procedures of the image generating device mentioned above will be described. FIG. 7 is a process flow chart of the image generating device.

First, the image generating device acquires the signal value of the subject by the image sensing unit 401 (S701). The face detecting unit 402 performs face detection process for the acquired signal value, and acquires face detection information (S702). The control unit 403 decides the photographing condition to photograph based on the detected face area and the signal value, and generates the image data, and outputs the conditions used in the control as the photographing information (S703). The image storage 404 combines the photographing information including the detected face area and the photographed image data to be stored as the image data of the data structure of FIG. 6 (S704).

The image data to which the photographing information including the detected face information is added are generated by the series of flows.

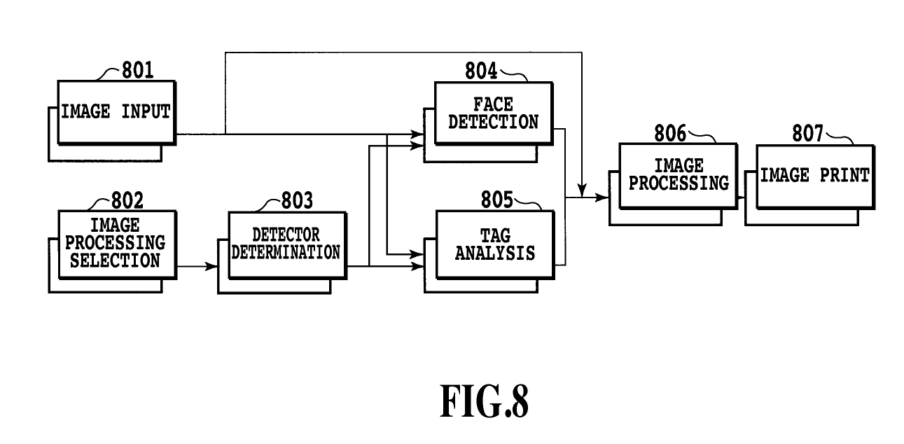

FIG. 8 illustrates a series of components in the configuration where the printing out or the like of the image data generated by the image generating device is performed by the image output device which is the printer or the like.

The image output device of the present embodiment includes an image input unit 801, an image processing selection unit 802, a detector determination unit 803, a face detector 804, a tag analyzer 805, an image processor 806, and an image printing unit 807, and each component performs processing according to a program.

The image input unit 801 reads the image data to which added is the photographing information including the information of the face area detected by the digital camera in advance.

The image processing selection unit 802 selects the image correction and the retouching process which are performed for the image data. The selection may be specified explicitly by a user, or the printer may select automatically according to a print setting or the like.

The detector determination unit 803, based on the type of the selected image processing, determines (which detector is to be used) whether to use the face area detected by the digital camera or the face area newly detected at the side of the printer.

The face detector 804 can analyze the image data at the side of the printer, and newly detect the face area. The face detection method, as described in the description of the image generating device, may be any kind of method such as the method using the already proposed pattern matching and the method using the learned data based on a neural network may be used.

The tag analyzer 805 acquires the detection result of the face area which is detected in advance by the digital camera and is added to the image data as the tag information (photographing information).

The image processor 806 performs image processing selectively using the information of the face area detected by the detector which is determined by the detector determination unit 803.

The image printing unit 807 prints the image processed in the image processor 806.

As typical image processing which the image processor 806 performs using the information of the detected face area, a red-eye correction technology and a backlight correction technology will be described.

First, the red-eye correction technology using the face area will be described.

An organ detection target area is determined from position information of the detected face area. Subsequently, the organ detection is performed for the determined organ detection target area. In the red-eye correction, eyes are detected. It is determined whether or not the detected eyes are red-eyes, and the red-eyes are corrected so as to be returned to an iris color with a natural hue.

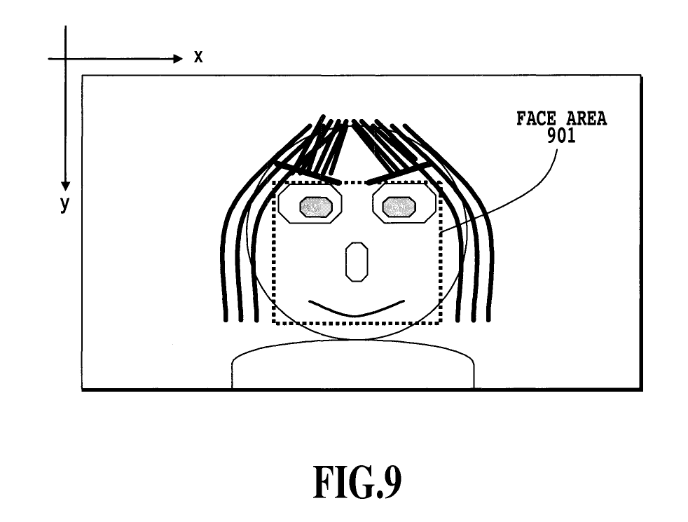

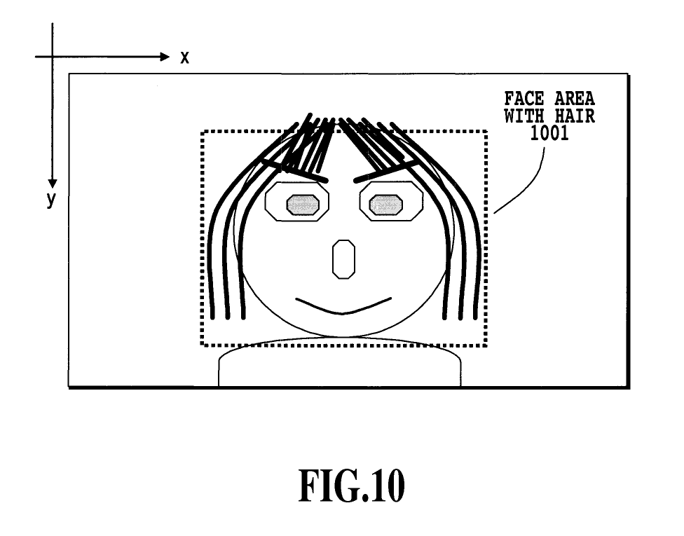

When only the skin-colored area including the eye/nose/mouth of FIG. 9 is a face area (a first face area 901), the eyes can be detected satisfactorily because the eyes are included in the area, and the red-eye correction can be carried out if the detected eyes are the red-eyes. When a face area further including the hair and the background of FIG. 10 in addition thereto is a face area (a second face area 1001), the eyes can be detected satisfactorily because the eyes are included in the area, and the red-eye correction can be carried out if the detected eyes are the red-eyes. Thus, the processing result of the red-eye correction does not differ due to a difference of the detected face areas. That is, even if the image processor 806 uses the detection result by the face detector 804 for the image from the image input unit 801, or even if the image processor 806 uses the detection result which the tag analyzer 805 acquires from the tag information from the image input unit 801, the red eye correction can be carried out optimally.

Furthermore, it is possible to make the somewhat wider area to be the organ detection target area with a margin added to the detected face area. Thereby, a face area difference between detectors which depends upon a difference and accuracy or the like of a face detection algorithm can be absorbed better.

By detecting whether a red point exists in a detection target area and analyzing detail features of the red point portion, it may be determined whether the point is a red-eye without performing the organ detection. It is important that the image processor 806 performs image processing using the information of the detected face area.

Subsequently, the backlight correction technology using the face area will be described.

A histogram in the face area is computed from the position information of the detected face area. An average value of the histogram is computed to give the luminance of the face area. In addition, the histogram is computed for all the areas of the image data to give the luminance of the image data. From the luminance of the computed face area and the luminance of the image data, a correction parameter with which the brightness of the face area becomes optimum is determined. The backlight correction is performed by the determined parameter.

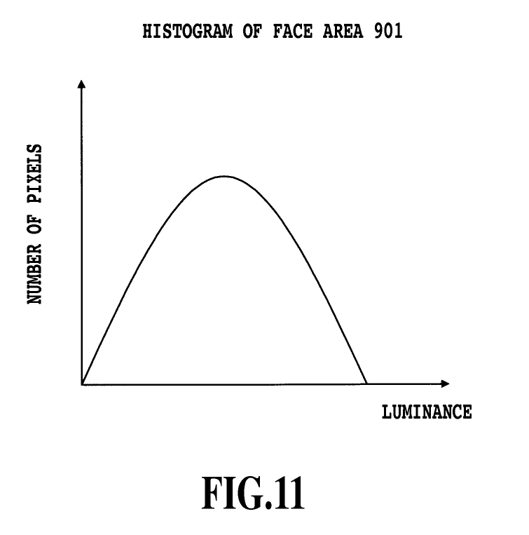

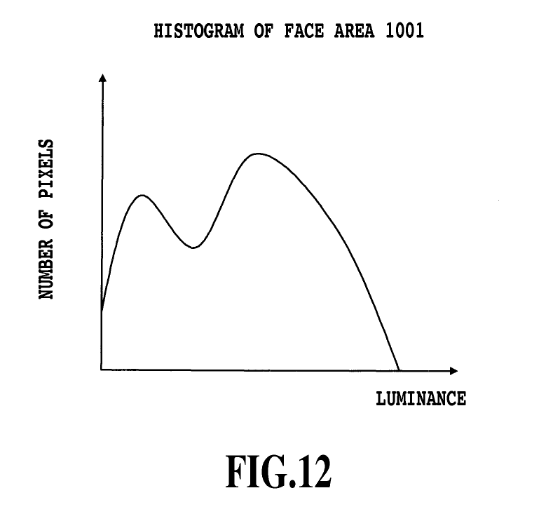

When only the skin-colored area including the eye/nose/mouth of FIG. 9 is the face area, the histogram in the face area will be as illustrated in FIG. 11. On the other hand, when the area further including the hair and the background of FIG. 10 in addition thereto is the face area, the histogram in the face area will be as illustrated in FIG. 12. The histogram of FIG. 12 appears for the distribution of a dark portion to increase because the hair is included. Two histograms differ largely. As for the backlight correction, since it is desirable to acquire the histogram of only the skin color of the face area in order to make the skin-color of the face area optimum, it is more desirable to utilize the histogram (FIG. 11) regarding the face area of FIG. 9. Therefore, when the face detection is performed by the printer in the present embodiment, only the skin color area including the eye/nose/mouth is detected by the face detector 804 to be utilized in the image processor 806, and thereby, the accuracy of the backlight correction is enhanced.

As mentioned above, as for the image processing, it turns out that there is the image processing in which the difference of the detected face area is largely related to the image processing result and there is the image processing in which the difference of the detected face area is not largely related to the image processing result. As for the image processing which uses only the position information of the detected face area (the above-mentioned red-eye correction technology), the difference of the detection result does not affect the image processing result easily. On the other hand, as for the image processing which uses the histogram in the detected face area (the above-mentioned backlight correction technology), the image processing result changes due to the difference of the detection result.

Regarding the image processing in which the difference in the detection result of the face area has no influence or small influence on the image processing result, the face detection is not performed at the side of the printer because the priority is given to the processing speed. The face area acquired in tag analyzer 805 which has been detected by the digital camera is used in the image processor 806. Such image processing mostly uses only the position information of the detection area. As the image processing in which using the face area detected by such digital camera will give more preferred result, there are the organ detection processing of a mouth, a nose, eyes, eyebrows or the like and an organic correction which performs a certain correction for these organs or the like in addition to the red eye detection mentioned above and the red-eye correction. As for the organic correction, the correction which opens the closed eyes will be possible. Furthermore, it is more preferred to use the face area detected by the digital camera in feature detection such as wrinkles/moles/stains which are not included in the organs, as well as in the characteristic correction which corrects these features. Furthermore, it is more preferred to use the face area detected by the digital camera in smile capturing which analyzes an organ or the like and determines whether the organ is a smiling face. And it is more preferred to use the face area detected by the digital camera also in a human sensing which analyzes an organ or the like and determines who the face is. It is more preferred to use the face area detected by the digital camera also in an automatic trimming technology in which trimming is performed based on the recognized face area. The image processing depending on the position information of these in the face area is called a first image processing.

On the other hand, regarding the image processing in which the difference of the detection result influences the image processing result, the face detection is performed at the side of the printer so as to be an optimum detection area for the image processing because the priority is given to the image processing result. And the face area detected by the face detector 804 at the side of the printer is used in the image processor 806. Such image processing mostly analyzes the distribution of color or luminance of the detection area as well as the correction amount. Thus, as the image processing in which using the face area detected by the face detector 804 will give more preferable result, a general exposure correction is included in addition to the backlight correction mentioned above. It is more preferred to use the face area detected at the side of the printer in a color dodge correction in which the exposure of only the subject is controlled and the other exposure is not changed mostly. Furthermore, it is more preferred to use the face area detected at the side of the printer in a skin smoothing which performs a tint correction and a smoothing correction for the skin of the face or the like to look more beautiful. The image processing which analyzes distribution of such color or luminance and the correction amount is called a second image processing.

The detector determination unit 803 determines (which detector is to be used) whether to use the face area detected by the digital camera or the face area newly detected at the side of the printer, based on the type of the selected image processing. The detector determination unit 803 examines, in advance, whether the image processing performed by the printer is influenced by the difference of the detection result and stores the type of the image processing and the detection result to be used in a database. Thereby, it is possible to determine which detection result is used by referring to the selected image processing in the database.

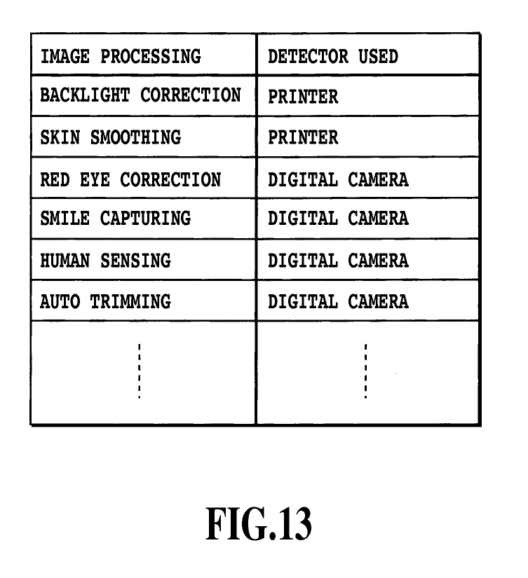

An example of the database is illustrated in FIG. 13 which shows the type of the image processing and the detector to be used corresponding thereto in a form of a table. When the image processing corresponding to “printer” is selected, the image processor 806 performs the selected process using the face area newly detected by the face detector 804. When the process corresponding to “digital camera” is selected, the image processor 806 performs the selected process using the face area acquired in the tag analyzer 805.

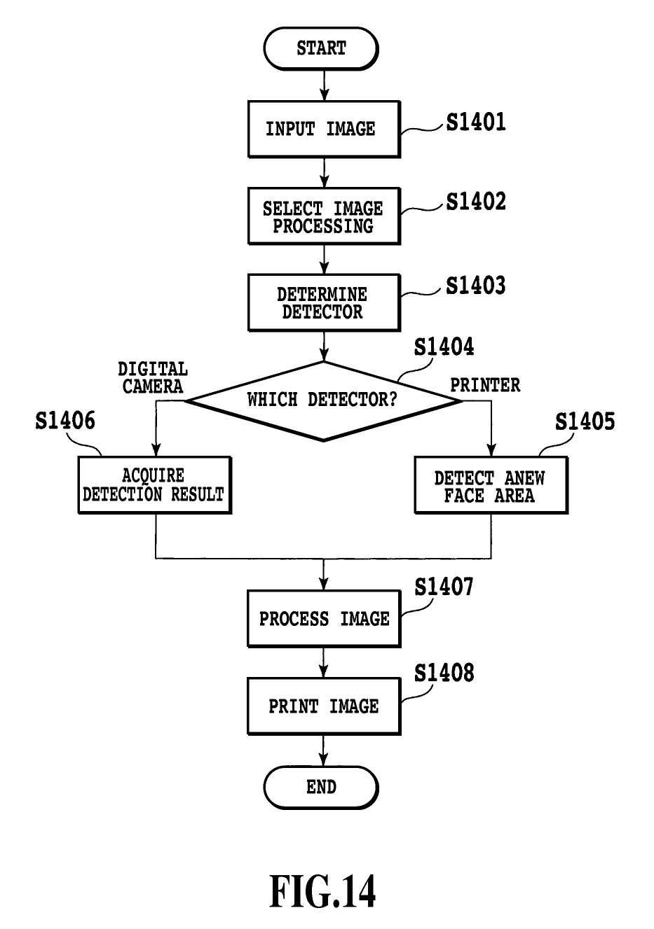

Subsequently, the processing procedure in the printer which is the image output device provided with the above-mentioned configuration according to the embodiment of the present invention will be described referring to the flow chart of FIG. 14.

First, the image data to which added is the photographing information including the face area detected by the digital camera in advance is read, by the image input unit 801, from the memory card 202 of FIG. 2, or from the hard disk which is provided to the personal computer 303 of FIG. 3 (S1401).

Subsequently, when the user selects the image processing performed for the image data in the image processing selection unit 802, the selection is received (S1402). It is possible for the printer to select the image processing automatically according to the print set or the like and to determine the process selected automatically in place of the user selection.

Referring to the database based on the type of the selected image processing, the detector determination unit 803 determines whether to use the face area recorded on the photographing information added to the image data, or whether to use the face area newly detected at the side of the printer (S1403, S1404).

When it is determined that the selected image processing is the one depending on the color distribution or the like in the face area and uses the face area detected by the printer, the face detector 804 analyzes the image data at the side of the printer and detects the face area a new (S1405).

On the other hand, when it is determined that the selected image processing is the one depending on the position information in the face area, and uses the face area recorded on the photographing information added to the image data, the process of step S1406 is performed. That is, the tag analyzer 805 acquires the detection result of the face area which is detected at the side of the digital camera and is added to the image data as the tag information. Here, the face area with a margin added to the face area photographed and detected by the digital camera may be used.

The image processor 806 performs the selected image processing (S1407) using the information of the face area detected by the detector determined by the detector determination unit 803.

Finally, the image printing unit 807 performs printing of the image-processed image (S1408). By the series of flows, the result of the image processing of the image data with the detected face information added thereto is printed.

According to the present embodiment, a processing time can be reduced by using the face detection result by the digital camera for the organ detection or the like in which the face area may be determined roughly. As for the color distribution or the like in the face area, since it is necessary to perform the face area detection which is optimum for a correction algorithm, the processing accuracy can be enhanced and the optimum processing result can be acquired by performing the face area detection at the side of the printer without using the detection result of unknown performance in the digital camera.

### Second Embodiment

In the present embodiment, when the same detection process as the face area detection performed on the image data stored in the memory card or the like is performed by the printer, processing contents can be reduced by using the detection result stored in the memory card or the like for pre-processing of the detection process in the printer.

In the case of performing the face area detection at the side of the printer, the performing of the face detection for all the areas of the image data will cause increasing the processing time. Therefore, at the side of the printer, performing the face detection only for the neighborhood area including the face area detected by the digital camera will be able to reduce the processing time rather than performing the face detection for all the areas. And since the face detection according to the image processing is performed at the side of the printer, the correction accuracy is also maintained.

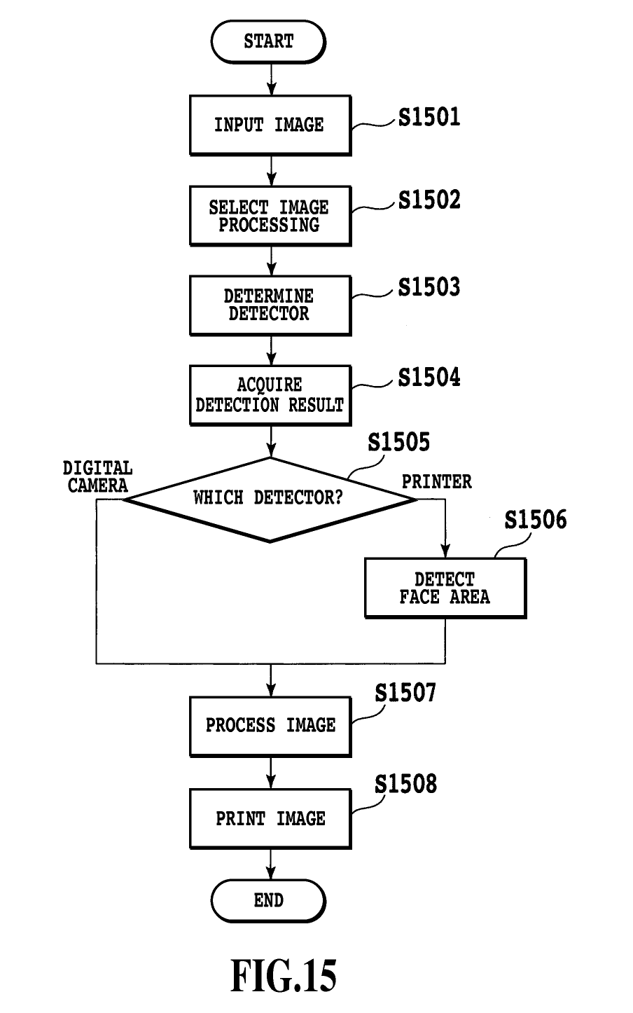

The present embodiment can be implemented by the same hardware configurations as the first embodiment. The image generating device and the image output device have the configurations illustrated in FIG. 4 and FIG. 8. Each component within FIG. 8 performs processing according to a program other than that of the first embodiment. The process flow of the image output device according to the present embodiment will be described referring FIG. 15.

First, the image data to which added is the face area detected by the digital camera in advance is read, by the image input unit 801, from the memory card 202 of FIG. 2, or from the hard disk which is provided to the personal computer 303 of FIG. 3 (S1501).

Subsequently, when the user selects the image processing performed for the image data in the image processing selection unit 802, the selection is received (S1502). It is possible for the printer to select the image processing automatically according to the print set or the like and to determine the process selected automatically in place of the user selection.

Referring to the database based on the type of the selected image processing, the detector determination unit 803 determines whether to use the face area added to the image data, or whether to use the face area which is newly detected at the side of the printer (S1503).

The tag analyzer 805 acquires the detection result of the face area which is detected at the digital camera and is added to the image data as the tag information (S1504). Here, the face area with a margin added to the face area photographed and detected by the digital camera may be used.

In step S1505, the process is branched according to a determination result in step S1503. If it is decided to use the face area detected by the digital camera, the detection result of the face area acquired in step S1504 is used.

If it is determined to use the face area detected by the printer, the face detector 804 determines the detection target area using the detection result acquired at step S1504 for pre-processing, and detects the face area newly in the neighborhood area which includes the face area detected by the digital camera (S1506).

The image processor 806 performs image processing using the information of the face area detected by the detector determined by the detector determination unit 803 (S1507). Finally, the image printing unit 807 performs printing of the image-processed image (S1508).

### Other Embodiment of the Present Invention

In the category of the above mentioned embodiments, included is a processing method for storing, in a storage medium, a program making the configurations of the embodiments mentioned above operate so as to realize the features of the embodiments mentioned above, and for reading the program stored in the medium as a code to be executed in a computer. Not only is the medium which stores the above-mentioned program, but also the program itself included in the embodiments mentioned above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present application claims the benefit of Japanese Patent Application No. 2008-166326, filed Jun. 25, 2008, which is hereby incorporated by reference herein in its entirety.

What is claimed is:

1. An image processing device having an image processing unit configured to perform a first image processing or a second image processing selectively for a target area of an image data, the device comprising:
a determining unit configured to determine an image processing selected from said first and second image processing; and
a detecting unit configured to detect a target area for an inputted image data;
wherein if it is determined that said first image processing is performed, said image processing unit performs said first image processing for the target area of said image data based on photographing information added to said image data in advance, and if it is determined that said second image processing is performed, said image processing unit performs said second image processing for the target area detected by said detecting unit.

2. The device according to claim 1, wherein said first image processing is performed using only position information in said target area, and said second image processing is performed in a manner that analyzes a distribution of color or luminance in said target area to analyze a correction amount thereof.

3. The device according to claim 2, wherein said target area is a face area.

4. The device according to claim 3, wherein said first image processing includes at least one of red eye detection, red eye correction, organ detection, organ correction, feature detection, feature correction, smile capturing, human sensing, and automatic trimming.

5. The device according to claim 3, wherein said second image processing includes at least one of exposure correction, backlight correction, skin smoothing, and color dodging.

6. The device according to claim 1, wherein said detecting unit performs detection of said target area using said photographing information added in advance.

7. A method of performing a first image processing or a second image processing selectively for a target area of an image data, the method comprising the steps of:
determining an image processing selected from said first and second image processing;
detecting a target area for an inputted image data; and
performing said image processing first or said second image processing selectively for the target area of said image data, wherein the step comprises performing said first image processing for the target area of said image data based on photographing information added to said image data in advance if it is determined in the determination step that said first image processing is performed, and performing said second image processing for the target area detected in the detection step if it is determined in the determination step that said second image processing is performed.

8. A computer readable medium storing thereon a computer program for causing a computer to execute the steps of:
determining an image processing selected from said first and second image processing;
detecting a target area for an inputted image data; and
performing said image processing first or said second image processing selectively for the target area of said image data, wherein the step comprises performing said first image processing for the target area of said image data based on photographing information added to said image data in advance if it is determined in the determination step that said first image processing is performed, and performing said second image processing for the target area detected in the detection step if it is determined in the determination step that said second image processing is performed.
